(19) United States
(12) Patent Application Publication
(10) Pub. No.: US 2021/0357739 A1
(43) Pub. Date: Nov. 18, 2021

(54) MEMORY DEVICE TO TRAIN NEURAL NETWORKS

(71) Applicant: Micron Technology, Inc., Boise, ID (US)

(72) Inventor: Vijay S. Ramesh, Boise, ID (US)

(21) Appl. No.: 15/931,664

(22) Filed: May 14, 2020

(51) Int. Cl. G06N 3/08; G06N 3/063; G06K 9/62

(52) U.S. Cl. CPC G06N 3/08; G06K 9/6256; G06N 3/0635

(57) ABSTRACT

Methods, systems, and apparatuses related to training neural networks are described. For example, data management and training of one or more neural networks may be accomplished within a memory device, such as a dynamic random-access memory (DRAM) device. Neural networks may thus be trained in the absence of specialized circuitry and/or in the absence of vast computing resources. One or more neural networks may be written or stored within memory banks of a memory device and operations may be performed within or adjacent to those memory banks to train different neural networks that are located in different banks of the memory device. This data management and training may occur within a memory system without involving a host device, processor, or accelerator that is external to the memory system. A trained network may then be read from the memory system and used for inference or other operations on an external device.

### TECHNICAL FIELD

The present disclosure relates generally to semiconductor memory and methods, and more particularly, to apparatuses, systems, and methods for a memory device to train neural networks.

### BACKGROUND

Memory devices are typically provided as internal, semiconductor, integrated circuits in computers or other electronic systems. There are many different types of memory including volatile and non-volatile memory. Volatile memory can require power to maintain its data (e.g., host data, error data, etc.) and includes random access memory (RAM), dynamic random access memory (DRAM), static random access memory (SRAM), synchronous dynamic random access memory (SDRAM), and thyristor random access memory (TRAM), among others. Non-volatile memory can provide persistent data by retaining stored data when not powered and can include NAND flash memory, NOR flash memory, and resistance variable memory such as phase change random access memory (PCRAM), resistive random access memory (RRAM), and magnetoresistive random access memory (MRAM), such as spin torque transfer random access memory (STT RAM), among others.

Memory devices may be coupled to a host (e.g., a host computing device) to store data, commands, and/or instructions for use by the host while the computer or electronic system is operating. For example, data, commands, and/or instructions can be transferred between the host and the memory device(s) during operation of a computing or other electronic system.

### BRIEF DESCRIPTION OF THE DRAWINGS

FIG. 1 is a functional block diagram in the form of an apparatus including a host and a memory device in accordance with a number of embodiments of the present disclosure.

FIG. 2A is a functional block diagram in the form of a memory device including control circuitry and a plurality of memory banks storing neural networks.

FIG. 2B is another functional block diagram in the form of a memory device including control circuitry and a plurality of memory banks storing a plurality of neural networks.

FIG. 3 is another functional block diagram in the form of a memory device including control circuitry and a plurality of memory banks storing neural networks.

FIG. 4 is a flow diagram representing an example method corresponding to a memory device to train neural networks in accordance with a number of embodiments of the present disclosure.

FIG. 5 is a flow diagram representing another example method corresponding to a memory device to train neural networks in accordance with a number of embodiments of the present disclosure.

FIG. 6 is a schematic diagram illustrating a portion of a memory array including sensing circuitry in accordance with a number of embodiments of the present disclosure.

### DETAILED DESCRIPTION

Methods, systems, and apparatuses related to training neural networks are described. For example, data management and training of one or more neural networks may be accomplished within a memory device, such as a dynamic random-access memory (DRAM) device. Neural networks may thus be trained in the absence of specialized circuitry and/or in the absence of vast computing resources. One or more neural networks may be written or stored within memory banks of a memory device and operations may be performed within or adjacent to those memory banks to train different neural networks that are located in different banks of the memory device. This data management and training may occur within a memory system without involving a host device, processor, or accelerator that is external to the memory system. A trained network may then be read from the memory system and used for inference or other operations on an external device.

A neural network can include a set of instructions that can be executed to recognize patterns in data. Some neural networks can be used to recognize underlying relationships in a set of data in a manner that mimics the way that a human brain operates. A neural network can adapt to varying or changing inputs such that the neural network can generate a best possible result in the absence of redesigning the output criteria.

A neural network can consist of multiple neurons, which can be represented by one or more equations. In the context of neural networks, a neuron can receive a quantity of numbers or vectors as inputs and, based on properties of the neural network, produce an output. For example, a neuron can receive Xₖ inputs, with k corresponding to an index of input. For each input, the neuron can assign a weight vector, Wₖ, to the input. The weight vectors can, in some embodiments, make the neurons in a neural network distinct from one or more different neurons in the network. In some neural networks, respective input vectors can be multiplied by respective weight vectors to yield a value, as shown by Equation 1, which shows and example of a linear combination of the input vectors and the weight vectors.

f(x₁,x₂)=+w₂x₂ Equation 1

In some neural networks, a non-linear function (e.g., an activation function) can be applied to the value f(x₁, x₂) that results from Equation 1. An example of a non-linear function that can be applied to the value that results from Equation 1 is a rectified linear unit function (ReLU). Application of the ReLU function, which is shown by Equation 2, yields the value input to the function if the value is greater than zero, or zero if the value input to the function is less than zero. The ReLU function is used here merely used as an illustrative example of an activation function and is not intended to be limiting. Other non-limiting examples of activation functions that can be applied in the context of neural networks can include sigmoid functions, binary step functions, linear activation functions, hyperbolic functions, leaky ReLU functions, parametric ReLU functions, softmax functions, and/or swish functions, among others.

ReLU(x)=max(x,0) Equation 2

During a process of training a neural network, the input vectors and/or the weight vectors can be altered to “tune” the network. In one example, a neural network can be initialized with random weights. Over time, the weights can be adjusted to improve the accuracy of the neural network. This can, over time yield a neural network with high accuracy.

Neural networks have a wide range of applications. For example, neural networks can be used for system identification and control (vehicle control, trajectory prediction, process control, natural resource management), quantum chemistry, general game playing, pattern recognition (radar systems, face identification, signal classification, 3D reconstruction, object recognition and more), sequence recognition (gesture, speech, handwritten and printed text recognition), medical diagnosis, finance (e.g. automated trading systems), data mining, visualization, machine translation, social network filtering and/or e-mail spam filtering, among others.

Due to the computing resources that some neural networks demand, in some approaches, neural networks are deployed in a computing system, such as a host computing system (e.g., a desktop computer, a supercomputer, etc.) or a cloud computing environment. In such approaches, data to be subjected to the neural network as part of an operation to train the neural network can be stored in a memory resource, such as a NAND storage device, and a processing resource, such as a central processing unit, can access the data and execute instructions to process the data using the neural network. Some approaches may also utilize specialized hardware such a field-programmable gate array or an application-specific integrated circuit as part of neural network training.

In contrast, embodiments herein are directed to data management and training of one or more neural networks within a volatile memory device, such as a dynamic random-access memory (DRAM) device. Accordingly, embodiments herein can allow for neural networks to be trained in the absence of specialized circuitry and/or in the absence of vast computing resources. As described in more detail herein, embodiments of the present disclosure include writing of one or more neural networks within memory banks of a memory device and performance of operations to use the neural networks to train different neural networks that are located in different banks of the memory device. For example, in some embodiments, a first neural network can be written to in a first memory bank (or first subset of memory banks) and a second neural network can be written to in a second memory bank (or second subset of memory banks). The first or second neural network can be used to train the other of the first or second neural network. Further, embodiments herein can allow for the other of the first neural network or the second neural network to be trained “on chip” (e.g., without encumbering a host coupled to the memory device and/or without transferring the neural network(s) to a location external to the memory device.

In the following detailed description of the present disclosure, reference is made to the accompanying drawings that form a part hereof, and in which is shown by way of illustration how one or more embodiments of the disclosure may be practiced. These embodiments are described in sufficient detail to enable those of ordinary skill in the art to practice the embodiments of this disclosure, and it is to be understood that other embodiments may be utilized and that process, electrical, and structural changes may be made without departing from the scope of the present disclosure.

As used herein, designators such as “X,” “N,” “M,” etc., particularly with respect to reference numerals in the drawings, indicate that a number of the particular feature so designated can be included. It is also to be understood that the terminology used herein is for the purpose of describing particular embodiments only, and is not intended to be limiting. As used herein, the singular forms “a,” “an,” and “the” can include both singular and plural referents, unless the context clearly dictates otherwise. In addition, “a number of,” “at least one,” and “one or more” (e.g., a number of memory banks) can refer to one or more memory banks, whereas a “plurality of” is intended to refer to more than one of such things.

Furthermore, the words “can” and “may” are used throughout this application in a permissive sense (i.e., having the potential to, being able to), not in a mandatory sense (i.e., must). The term “include,” and derivations thereof, means “including, but not limited to.” The terms “coupled” and “coupling” mean to be directly or indirectly connected physically or for access to and movement (transmission) of commands and/or data, as appropriate to the context. The terms “data” and “data values” are used interchangeably herein and can have the same meaning, as appropriate to the context.

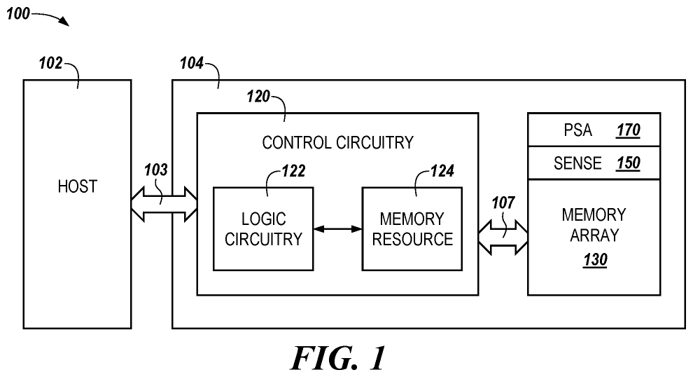

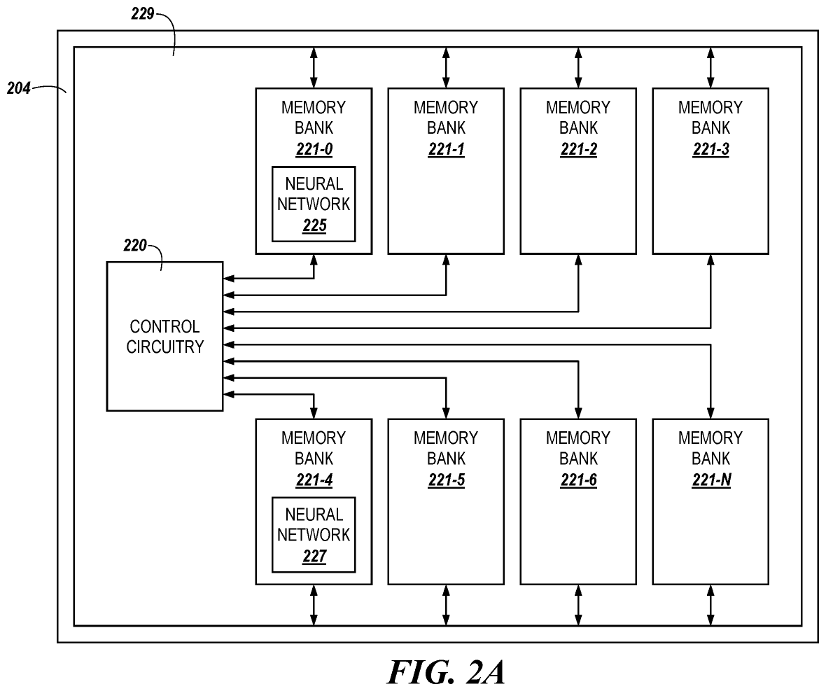

The figures herein follow a numbering convention in which the first digit or digits correspond to the figure number and the remaining digits identify an element or component in the figure. Similar elements or components between different figures may be identified by the use of similar digits. For example, 104 may reference element “04” in FIG. 1, and a similar element may be referenced as 204 in FIG. 2. A group or plurality of similar elements or components may generally be referred to herein with a single element number. For example, a plurality of reference elements 221-1 to 221-N (or, in the alternative, 221-1, . . . , 221-N) may be referred to generally as 221. As will be appreciated, elements shown in the various embodiments herein can be added, exchanged, and/or eliminated so as to provide a number of additional embodiments of the present disclosure. In addition, the proportion and/or the relative scale of the elements provided in the figures are intended to illustrate certain embodiments of the present disclosure and should not be taken in a limiting sense.

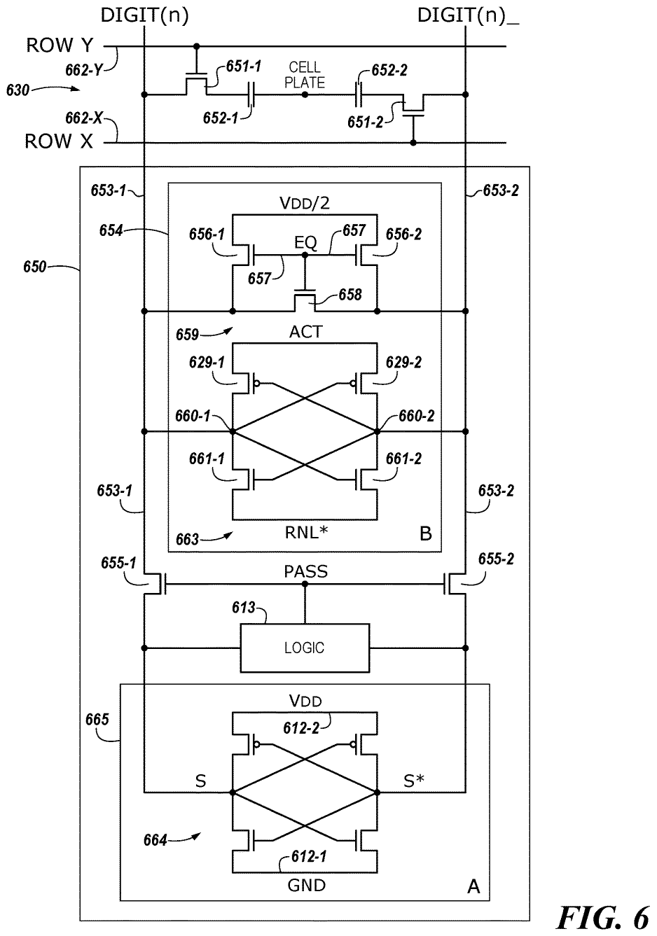

FIG. 1 is a functional block diagram in the form of a computing system 100 including an apparatus including a host 102 and a memory device 104 in accordance with a number of embodiments of the present disclosure. As used herein, an “apparatus” can refer to, but is not limited to, any of a variety of structures or combinations of structures, such as a circuit or circuitry, a die or dice, a module or modules, a device or devices, or a system or systems, for example. The memory device 104 can include a one or more memory modules (e.g., single in-line memory modules, dual in-line memory modules, etc.). The memory device 104 can include volatile memory and/or non-volatile memory. In a number of embodiments, memory device 104 can include a multi-chip device. A multi-chip device can include a number of different memory types and/or memory modules. For example, a memory system can include non-volatile or volatile memory on any type of a module. As shown in FIG. 1, the apparatus 100 can include control circuitry 120, which can include logic circuitry 122 and a memory resource 124, a memory array 130, and sensing circuitry 150 (e.g., the SENSE 150). Examples of the sensing circuitry 150 are describe in more detail in connection with FIG. 6, herein. For instance, in a number of embodiments, the sensing circuitry 150 can include a number of sense amplifiers and corresponding compute components, which may serve as an accumulator and can be used to perform neural network training operations using trained and untrained neural networks stored in the memory array 130. In addition, each of the components (e.g., the host 102, the control circuitry 120, the logic circuitry 122, the memory resource 124, the memory array 130, and/or the sensing circuitry 150) can be separately referred to herein as an “apparatus.” The control circuitry 120 may be referred to as a “processing device” or “processing unit” herein.

The memory device 104 can provide main memory for the computing system 100 or could be used as additional memory or storage throughout the computing system 100. The memory device 104 can include one or more memory arrays 130 (e.g., arrays of memory cells), which can include volatile and/or non-volatile memory cells. The memory array 130 can be a flash array with a NAND architecture, for example. Embodiments are not limited to a particular type of memory device. For instance, the memory device 104 can include RAM, ROM, DRAM, SDRAM, PCRAM, RRAM, and flash memory, among others.

In embodiments in which the memory device 104 includes non-volatile memory, the memory device 104 can include flash memory devices such as NAND or NOR flash memory devices. Embodiments are not so limited, however, and the memory device 104 can include other non-volatile memory devices such as non-volatile random-access memory devices (e.g., NVRAM, ReRAM, FeRAM, MRAM, PCM), “emerging” memory devices such as resistance variable (e.g., 3-D Crosspoint (3D XP)) memory devices, memory devices that include an array of self-selecting memory (SSM) cells, etc., or combinations thereof.

Resistance variable memory devices can perform bit storage based on a change of bulk resistance, in conjunction with a stackable cross-gridded data access array. Additionally, in contrast to many flash-based memories, resistance variable non-volatile memory can perform a write in-place operation, where a non-volatile memory cell can be programmed without the non-volatile memory cell being previously erased. In contrast to flash-based memories and resistance variable memories, self-selecting memory cells can include memory cells that have a single chalcogenide material that serves as both the switch and storage element for the memory cell.

As illustrated in FIG. 1, a host 102 can be coupled to the memory device 104. In a number of embodiments, the memory device 104 can be coupled to the host 102 via one or more channels (e.g., channel 103). In FIG. 1, the memory device 104 is coupled to the host 102 via channel 103 and control circuitry 120 of the memory device 104 is coupled to the memory array 130 via a channel 107. The host 102 can be a host system such as a personal laptop computer, a desktop computer, a digital camera, a smart phone, a memory card reader, and/or an internet-of-things (IoT) enabled device, among various other types of hosts.

The host 102 can include a system motherboard and/or backplane and can include a memory access device, e.g., a processor (or processing device). One of ordinary skill in the art will appreciate that “a processor” can intend one or more processors, such as a parallel processing system, a number of coprocessors, etc. The system 100 can include separate integrated circuits or both the host 102, the memory device 104, and the memory array 130 can be on the same integrated circuit. The system 100 can be, for instance, a server system and/or a high-performance computing (HPC) system and/or a portion thereof. Although the example shown in FIG. 1 illustrate a system having a Von Neumann architecture, embodiments of the present disclosure can be implemented in non-Von Neumann architectures, which may not include one or more components (e.g., CPU, ALU, etc.) often associated with a Von Neumann architecture.

The memory device 104, which is shown in more detail in FIG. 2, herein, can include control circuitry 120, which can include logic circuitry 122 and a memory resource 124. The logic circuitry 122 can be provided in the form of an integrated circuit, such as an application-specific integrated circuit (ASIC), field programmable gate array (FPGA), reduced instruction set computing device (RISC), advanced RISC machine, system-on-a-chip, or other combination of hardware and/or circuitry that is configured to perform operations described in more detail, herein. In some embodiments, the logic circuitry 122 can comprise one or more processors (e.g., processing device(s), processing unit(s), etc.)

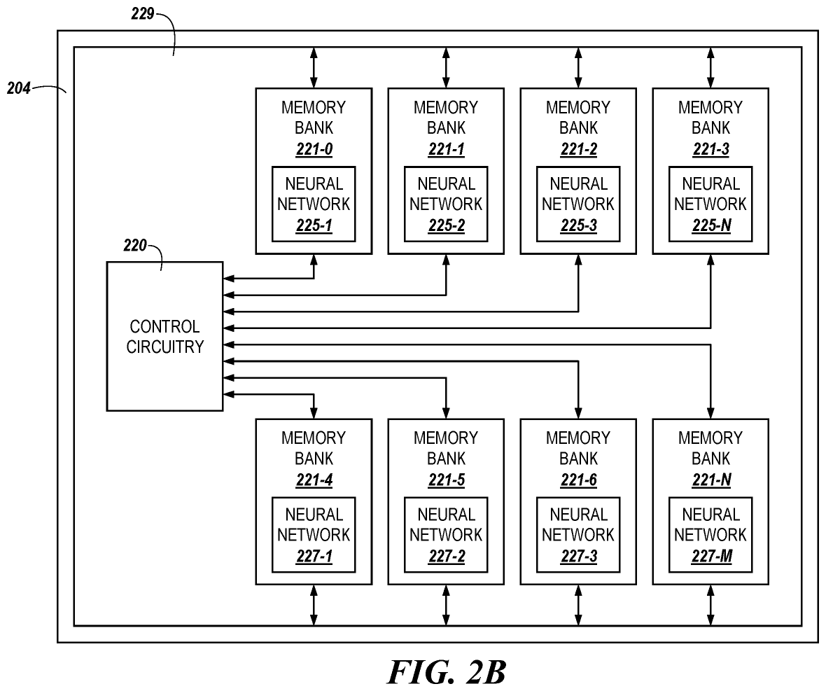

The logic circuitry 122 can perform operations to control access to and from the memory array 130 and/or the sense amps 150. For example, the logic circuitry 122 can perform operations to control storing of one of more neural networks within the memory array 130, as described in connection with FIGS. 2 and 3, herein. In some embodiments, the logic circuitry 122 can receive a command from the host 102 and can, in response to receipt of the command, control storing of the neural network(s) in the memory array 130. Embodiments are not so limited, however, and, in some embodiments, the logic circuitry 122 can cause the neural network(s) to be stored in the memory array 130 in the absence of a command from the host 102. As described in more detail in connection with FIGS. 2 and 3, herein, at least one of the stored neural networks can be trained prior to being stored in the memory array 130. Similarly, in some embodiments, at least one of the stored neural networks can be untrained prior to being stored in the memory array 130.

Once the neural network(s) are stored in the memory array 130, the logic circuitry 122 can control initiation of operations using the stored neural network(s). For example, in some embodiments, the logic circuitry 122 can control initiation of operations to use one or more stored neural networks (e.g., one or more trained neural networks) to train other neural networks (e.g., one or more untrained neural networks) stored in the memory array 130. However, once the operation(s) to train the untrained neural networks have been initiated, training operations can be performed within the memory array 130 in the absence of additional commands from the logic circuitry 122 and/or the host 102.

The control circuitry 120 can further include a memory resource 124, which can be communicatively coupled to the logic circuitry 122. The memory resource 124 can include volatile memory resource, non-volatile memory resources, or a combination of volatile and non-volatile memory resources. In some embodiments, the memory resource can be a random-access memory (RAM) such as static random-access memory (SRAM). Embodiments are not so limited, however, and the memory resource can be a cache, one or more registers, NVRAM, ReRAM, FeRAM, MRAM, PCM), “emerging” memory devices such as resistance variable memory resources, phase change memory devices, memory devices that include arrays of self-selecting memory cells, etc., or combinations thereof. In some embodiments, the memory resource 124 can serve as a cache for the logic circuitry 122.

As shown in FIG. 1, sensing circuitry 150 is coupled to a memory array 130 and the control circuitry 120. The sensing circuitry 150 can include one or more sense amplifiers and one or more compute components. The sensing circuitry 150 can provide additional storage space for the memory array 130 and can sense (e.g., read, store, cache) data values that are present in the memory device 104. In some embodiments, the sensing circuitry 150 can be located in a periphery area of the memory device 104. For example, the sensing circuitry 150 can be located in an area of the memory device 104 that is physically distinct from the memory array 130. The sensing circuitry 150 can include sense amplifiers, latches, flip-flops, etc. that can be configured to stored data values, as described herein. In some embodiments, the sensing circuitry 150 can be provided in the form of a register or series of registers and can include a same quantity of storage locations (e.g., sense amplifiers, latches, etc.) as there are rows or columns of the memory array 130. For example, if the memory array 130 contains around 16K rows or columns, the sensing circuitry 150 can include around 16K storage locations. Accordingly, in some embodiments, the sensing circuitry 150 can be a register that is configured to hold up to 16K data values, although embodiments are not so limited.

Periphery sense amplifiers (“PSA”) 170 can be coupled to the memory array 130, the sensing circuitry 150, and/or the control circuitry 120. The periphery sense amplifiers 170 can provide additional storage space for the memory array 130 and can sense (e.g., read, store, cache) data values that are present in the memory device 104. In some embodiments, the periphery sense amplifiers 170 can be located in a periphery area of the memory device 104. For example, the periphery sense amplifiers 170 can be located in an area of the memory device 104 that is physically distinct from the memory array 130. The periphery sense amplifiers 170 can include sense amplifiers, latches, flip-flops, etc. that can be configured to stored data values, as described herein. In some embodiments, the periphery sense amplifiers 170 can be provided in the form of a register or series of registers and can include a same quantity of storage locations (e.g., sense amplifiers, latches, etc.) as there are rows or columns of the memory array 130. For example, if the memory array 130 contains around 16K rows or columns, the periphery sense amplifiers 170 can include around 16K storage locations.

The periphery sense amplifiers 170 can be used in conjunction with the sensing circuitry 150 and/or the memory array 130 to facilitate performance of the neural network training operations described herein. For example, in some embodiments, the periphery sense amplifiers 170 can store portions of the neural networks (e.g., the neural networks 225 and 227 described in connection with FIGS. 2A and 2B, herein) and/or store commands (e.g., PIM commands) to facilitate performance of neural network training operations that are performed within the memory device 104.

The embodiment of FIG. 1 can include additional circuitry that is not illustrated so as not to obscure embodiments of the present disclosure. For example, the memory device 104 can include address circuitry to latch address signals provided over I/O connections through I/O circuitry. Address signals can be received and decoded by a row decoder and a column decoder to access the memory device 104 and/or the memory array 130. It will be appreciated by those skilled in the art that the number of address input connections can depend on the density and architecture of the memory device 104 and/or the memory array 130.

FIG. 2A is a functional block diagram in the form of a memory device 204 including control circuitry 220 and a plurality of memory banks 221-0 to 221-N storing neural networks 225/227. The control circuitry 220, the memory banks 221-0 to 221-N, and/or the neural networks 225/227 can be referred to separately or together as an apparatus. As used herein, an “apparatus” can refer to, but is not limited to, any of a variety of structures or combinations of structures, such as a circuit or circuitry, a die or dice, a module or modules, a device or devices, or a system or systems, for example. The memory device 204 can be analogous to the memory device 104 illustrated in FIG. 1, while the control circuitry 220 can be analogous to the control circuitry 120 illustrated in FIG. 1.

The control circuitry 220 can allocate a plurality of locations in the arrays of each respective memory bank 221-0 to 221-N to store bank commands, application instructions (e.g., for sequences of operations), and arguments (e.g., processing in memory (PIM) commands) for the various memory banks 221-0 to 221-N associated with operations of the memory device 204. The control circuitry 220 can send commands (e.g., PIM commands) to the plurality of memory banks 221-0 to 221-N to store those program instructions within a given memory bank 221-0 to 221-N. As used herein, “PIM commands” are commands executed by processing elements within a memory bank 221-0 to 221-N (e.g., via the sensing circuitry 150 illustrated in FIG. 1), as opposed to normal DRAM commands (e.g., read/write commands) that result in data being operated on by an external processing component such as the host 120 illustrated in FIG. 1. Accordingly, PIM commands can correspond to commands to perform operations within the memory banks 221-1 to 221-N without encumbering the host.

In some embodiments, the PIM commands can be executed within the memory device 204 to store a trained neural network (e.g., the neural network 225) in one of the memory banks (e.g., the memory bank 221-0), store an untrained neural network (e.g., the neural network 227) in a different memory bank (e.g., the memory bank 221-4), and/or cause performance of operations to train the untrained neural network using the trained neural network.

As mentioned above, the neural network 225 and/or the neural network 227 can be trained over time using input data sets to improve the accuracy of the neural networks 225/227. However, in some embodiments, at least one of the neural networks (e.g., the neural network 225) can be trained prior to being stored in one of the memory banks 221-0 to 221-N. In such embodiments, the other neural network(s) (e.g., the neural network 227) can be untrained prior to being stored in the memory banks 221-0 to 221-N. Continuing with this example, the untrained neural network (e.g., the neural network 227) can be trained by the trained neural network (e.g., the neural network 225).

The memory banks 221-0 to 221-N can be communicatively coupled via a bus 229 (e.g., a bank-to-bank transfer bus, communication sub-system, etc.). The bus 229 can facilitate transfer of data and/or commands between the memory banks 221-0 to 221-N. In some embodiments, the bus 229 can facilitate transfer of data and/or commands between the memory banks 221-0 to 221-N as part of performance of an operation to train an untrained neural network (e.g., the neural network 227) using a trained neural network (e.g., the neural network 225).

FIG. 2B is another functional block diagram in the form of a memory device 204 including control circuitry 220 and a plurality of memory banks 221-0 to 221-N storing a plurality of neural networks 225-1 to 225-N and 227-1 to 227-M. The control circuitry 220, the plurality of memory banks 221-0 to 221-N, and the neural networks 225 and 227 can be analogous to the control circuitry 220, the plurality of memory banks 221-0 to 221-N, and the neural networks 225 and 227 illustrated in FIG. 2A.

In some embodiments, respective trained neural networks (e.g., the neural networks 225-1 to 225-N) can perform operations to train respective untrained neural networks (e.g., the neural networks 227-1 to 227-M). For example, an untrained neural network 227-1 can be trained by a trained neural network 225-1, an untrained neural network 227-2 can be trained by a trained neural network 225-2, an untrained neural network 227-3 can be trained by a trained neural network 225-3, and/or an untrained neural network 227-M can be trained by a trained neural network 225-N, as describe elsewhere herein.

The untrained neural networks (e.g., the neural networks 227-1 to 227-M) can be trained by the trained neural networks (e.g., the neural networks 225-1 to 225-N) substantially concurrently (e.g., in parallel). As used herein, the term “substantially” intends that the characteristic need not be absolute, but is close enough so as to achieve the advantages of the characteristic. For example, “substantially concurrently” is not limited to operations that are performed absolutely concurrently and can include timings that are intended to be concurrent but due to manufacturing limitations may not be precisely concurrent. For example, due to read/write delays that may be exhibited by various interfaces and/or buses, training operations for the untrained neural networks that are performed “substantially concurrently” may not start or finish at exactly the same time. However, at least one of a first untrained neural network (e.g., the neural network 227-1) and a second untrained neural network (e.g., the neural network 227-2) may be trained by respective trained neural networks (e.g., the neural network 225-1 and the neural network 225-2) such that the training operations are being performed at the same time regardless of whether the training operations for the first untrained neural network and the second untrained neural network commences or terminates prior to the other. Embodiments are not so limited, however, and in some embodiments, the untrained neural networks (e.g., the neural networks 227-1 to 227-M) can be trained by the trained neural network 225-1 to 225-N.

In some embodiments, the trained neural networks (e.g., the neural networks 225-1 to 225-N) and/or the untrained neural networks (e.g., the neural networks 227-1 to 227-M) can be portions or sub-sets of a larger neural network. For example, one trained or untrained neural networks can be broken into smaller constituent portions and stored across multiple banks 221 of the memory device 204. In some embodiments, the control circuitry 220 can control splitting the entire neural networks into the constituent portions or sub-sets. By allowing for a neural network to be split into smaller constituent portions or sub-sets, storing and/or training of neural networks can be realized within the storage limitations of a memory device 204 that includes multiple memory banks 221-0 to 221-N.

In a non-limiting example, a system can include a memory device 204 that includes eight memory banks 221-0 to 220-N. The system can further include control circuitry 220 resident on the memory device 204 and communicatively coupled to the eight memory banks 221-0 to 221-N. As used herein, the term “resident on” refers to something that is physically located on a particular component. For example, the control circuitry 220 being “resident on” the memory device 204 refers to a condition in which the hardware circuitry that comprises the control circuitry 220 is physically located on the memory device 204. The term “resident on” may be used interchangeably with other terms such as “deployed on” or “located on,” herein.

The control circuitry 220 can control storing of four distinct trained neural networks (e.g., the neural networks 225-1, 225-2, 225-3 and 225-N) in four of the memory banks (e.g., the memory banks 221-0, 221-1, 221-2, and 221-3). The control circuitry 220 can further control storing of four distinct untrained neural networks (e.g., the neural networks 227-1, 227-2, 227-3 and 227-N) in a different four of the memory banks (e.g., the memory banks 221-4, 221-5, 221-6, and 221-N) such that each of the eight memory banks 221-0 to 221-N stores a trained neural network or an untrained neural network. In some embodiments, at least two of the trained neural networks and/or at least two of the untrained neural networks can be different types of neural networks.

For example, at least two of the trained neural networks and/or at least two of the untrained neural networks can be feed-forward neural networks or back-propagation neural networks. Embodiments are not so limited, however, and at least two of the trained neural network and/or at least two of the untrained neural networks can be perceptron neural networks, radial basis neural networks, deep feed forward neural networks, recurrent neural networks, long/short term memory neural networks, gated recurrent unit neural networks, auto encoder (AE) neural networks, variational AE neural networks, denoising AE neural networks, sparse AE neural networks, Markov chain neural networks, Hopfield neural networks, Boltzmann machine (BM) neural networks, restricted BM neural networks, deep belief neural networks, deep convolution neural networks, deconvolutional neural networks, deep convolutional inverse graphics neural networks, generative adversarial neural networks, liquid state machine neural networks, extreme learning machine neural networks, echo state neural networks, deep residual neural networks, Kohonen neural networks, support vector machine neural networks, and/or neural Turing machine neural networks, among others.

In some embodiments, the control circuitry 220 can control, in the absence of signaling generated by circuitry external to the memory device 204, performance of a plurality of neural network training operations to cause the untrained neural networks to be trained by the trained neural networks. By performing neural network training in the absence of signaling generated by circuitry external to the memory device 204 (e.g., by performing neural network training within the memory device 204 or “on chip”), data movement to and from the memory device 204 can be reduced in comparison to approaches that do not perform neural network training within the memory device 204. This can allow for a reduction in power consumption in performing neural network training operations and/or a reduction in dependence on a host computing system (e.g., the host 102 illustrated in FIG. 1). In addition, neural network training can be automized, which can reduce an amount of time spent in training the neural networks.

As used herein, “neural network training operations” include operations that are performed to determine one or more hidden layers of at least one of the neural networks. In general, a neural network can include at least one input layer, at least one hidden layer, and at least one output layer. The layers can include multiple neurons that can each receive an input and generate a weighted output. In some embodiments, the neurons of the hidden layer(s) can calculate weighted sums and/or averages of inputs received from the input layer(s) and their respective weights and pass such information to the output layer(s).

In some embodiments, the neural network training operations can be performed by utilizing knowledge learned by the trained neural networks during their training to train the untrained neural networks. This can reduce the amount of time and resources spent in training untrained neural networks by reducing retraining of information that has already been learned by the trained neural networks. In addition, embodiments herein can allow for a neural network that has been trained under a particular training methodology to train an untrained neural network with a different training methodology. For example, a neural network can be trained under a Tensorflow methodology and can then train an untrained neural network under a MobileNet methodology (or vice versa). Embodiments are not limited to these specific examples, however, and other training methodologies are contemplated within the scope of the disclosure.

As describe above, in some embodiments, the control circuitry 220 can control performance of the plurality of the neural network training operations such that the plurality of neural network training operations can be performed substantially concurrently.

The control circuitry 220 can, in some embodiments, cause performance of operations to convert data associated with the neural networks (e.g., the trained neural networks and/or the untrained neural networks) from one data type to another data type prior to causing the trained and/or untrained neural networks to be stored in the memory banks 221-0 to 221-N and/or prior to transferring the neural networks to circuitry external to the memory device 204. As used herein, a “data type” generally refers to a format in which data is stored. Non-limiting examples of data types include the IEEE 754 floating-point format, the fixed-point binary format, and/or universal number (unum) formats such as Type III unums and/or posits. Accordingly, in some embodiments, the control circuitry 220 can cause performance of operations to convert data associated with the neural networks (e.g., the trained neural networks and/or the untrained neural networks) from a floating-point or fixed point binary format to a universal number or posit format prior to causing the trained and/or untrained neural networks to be stored in the memory banks 221-0 to 221-N and/or prior to transferring the neural networks to circuitry external to the memory device 204.

In contrast to the IEEE 754 floating-point or fixed-point binary formats, which include a sign bit sub-set, a mantissa bit sub-set, and an exponent bit sub-set, universal number formats, such as posits include a sign bit sub-set, a regime bit sub-set, a mantissa bit sub-set, and an exponent bit sub-set. This can allow for the accuracy, precision, and/or the dynamic range of a posit to be greater than that of a float, or other numerical formats. In addition, posits can reduce or eliminate the overflow, underflow, NaN, and/or other corner cases that are associated with floats and other numerical formats. Further, the use of posits can allow for a numerical value (e.g., a number) to be represented using fewer bits in comparison to floats or other numerical formats.

In some embodiments, the control circuitry 220 can determine that at least one of the untrained neural networks has been trained and cause the neural network that has been trained to be transferred to circuitry external to the memory device 204. Further, in some embodiments, the control circuitry 220 can determine that at least one of the untrained neural networks has been trained and cause performance of an operation to alter a precision, a dynamic range, or both, of information (e.g., data) associated with the neural network that has been trained. Embodiments are not so limited, however, and in some embodiments, the control circuitry 220 can cause performance of an operation to alter a precision, a dynamic range, or both, of information (e.g., data) associated with the trained or untrained neural networks prior to the trained or untrained neural networks being stored in the memory banks 221-0 to 221-N.

As used herein, a “precision” refers to a quantity of bits in a bit string that are used for performing computations using the bit string. For example, if each bit in a 16-bit bit string is used in performing computations using the bit string, the bit string can be referred to as having a precision of 16 bits. However, if only 8-bits of a 16-bit bit string are used in performing computations using the bit string (e.g., if the leading 8 bits of the bit string are zeros), the bit string can be referred to as having a precision of 8-bits. As the precision of the bit string is increased, computations can be performed to a higher degree of accuracy. Conversely, as the precision of the bit string is decreased, computations can be performed using to a lower degree of accuracy. For example, an 8-bit bit string can correspond to a data range consisting of two hundred and fifty-five (256) precision steps, while a 16-bit bit string can correspond to a data range consisting of sixty-five thousand five hundred and thirty-six (63,536) precision steps.

As used herein, a “dynamic range” or “dynamic range of data” refers to a ratio between the largest and smallest values available for a bit string having a particular precision associated therewith. For example, the largest numerical value that can be represented by a bit string having a particular precision associated therewith can determine the dynamic range of the data format of the bit string. For a universal number (e.g., a posit) format bit string, the dynamic range can be determined by the numerical value of the exponent bit sub-set of the bit string.

A dynamic range and/or the precision can have a variable range threshold associated therewith. For example, the dynamic range of data can correspond to an application that uses the data and/or various computations that use the data. This may be due to the fact that the dynamic range desired for one application may be different than a dynamic range for a different application, and/or because some computations may require different dynamic ranges of data. Accordingly, embodiments herein can allow for the dynamic range of data to be altered to suit the requirements of disparate applications and/or computations. In contrast to approaches that do not allow for the dynamic range of the data to be manipulated to suit the requirements of different applications and/or computations, embodiments herein can improve resource usage and/or data precision by allowing for the dynamic range of the data to varied based on the application and/or computation for which the data will be used.

FIG. 3 is another functional block diagram in the form of a memory device 304 including control circuitry 320 and a plurality of memory banks 321-0 to 321-N storing neural networks 325/327. The control circuitry 320, the memory banks 321-0 to 321-N, and/or the neural networks 325/227 can be referred to separately or together as an apparatus. As used herein, an “apparatus” can refer to, but is not limited to, any of a variety of structures or combinations of structures, such as a circuit or circuitry, a die or dice, a module or modules, a device or devices, or a system or systems, for example. The memory device 304 can be analogous to the memory device 204 illustrated in FIGS. 2A and 2B, while the control circuitry 320 can be analogous to the control circuitry 220 illustrated in FIGS. 2A and 2B. The memory banks 321-0 to 321-N can be analogous to the memory banks 221-0 to 221-N illustrated in FIGS. 2A and 2B, the neural network 325 can be analogous to the neural network 225 illustrated in FIGS. 2A and 2B, and the neural network 327 can be analogous to the neural network 227 illustrated in FIGS. 2A and 2B, herein. Although not explicitly shown in FIG. 3, the memory banks 321-0 to 321-N can be communicatively coupled to one another via a bus, such as the bus 229 illustrated in FIGS. 2A and 2B, herein.

As shown in FIG. 3, the neural network 325 and the neural network 327 can be spread across multiple memory banks 321 of the memory device 304. For example, a first subset of memory banks (e.g., the memory banks 321-0 to 321-3) can be configured as a subset of memory banks to store the neural network 325 and a second subset of memory banks (e.g., the memory banks 321-4 to 321-N) can be configured as a subset of memory banks to store the neural network 327. For example, in some embodiments, the first subset of banks can comprise half of a total quantity of memory banks 321-0 to 321-N associated with the memory device 304 and the second subset of banks can comprise another half of the total quantity of memory banks 321-0 to 321-N associated with the memory device 304. Embodiments are not limited to this particular configuration, however, and the memory banks 321 can be divided into more than two subsets and/or the subsets may include greater than four memory banks 321 and/or fewer than four memory banks 321.

In a non-limiting example, an apparatus can include a memory device 304 comprising a plurality of banks of memory cells 321-0 to 321-N and control circuitry 320 resident on the memory device 304 and communicatively coupled to each bank among the plurality of memory banks 321-0 to 321-N. In some embodiments, the control circuitry 320 can control storing of a first neural network (e.g., the neural network 325) in a first subset of banks (e.g., the memory banks 321-0 to 321-3) of the plurality of memory banks 321-0 to 321-N. The control circuitry 320 can further control storing of a second neural network (e.g., the neural network 327) in a second subset of banks (e.g., the memory banks 321-4 to 321-N) of the plurality of memory banks 321-0 to 321-N and/or control performance of a neural network training operation to cause the second neural network to be trained by the first neural network. Embodiments are not so limited, however, and in some embodiments, the control circuitry 320 can control storing of a third neural network in a third subset of banks of the plurality of memory banks and can control performance of the neural network training operation to cause the third neural network to be trained by the first neural network and/or the second neural network.

The first neural network can be trained prior to being stored in the first subset of banks of the plurality of memory banks 321-0 to 321-N and the second neural network may not be trained (e.g., the second neural network may be untrained) prior to being stored in the second subset of banks of the plurality of memory banks 321-0 to 321-N. Accordingly, in some embodiments, the second neural network can be trained by the first neural network.

As described in more detail above, the control circuitry 320 can control storing of the first neural network, storing of the second neural network, or performance of the neural network training operation, or any combination thereof, in the absence of signaling generated by a component external to the memory device 304. For example, the storing of the first neural network, storing of the second neural network, or performance of the neural network training operation, or any combination thereof can be performed entirely within the memory device 304 without requiring additional input from a host (e.g., the host 102 illustrated in FIG. 1) or other circuitry that is external to the memory device 304.

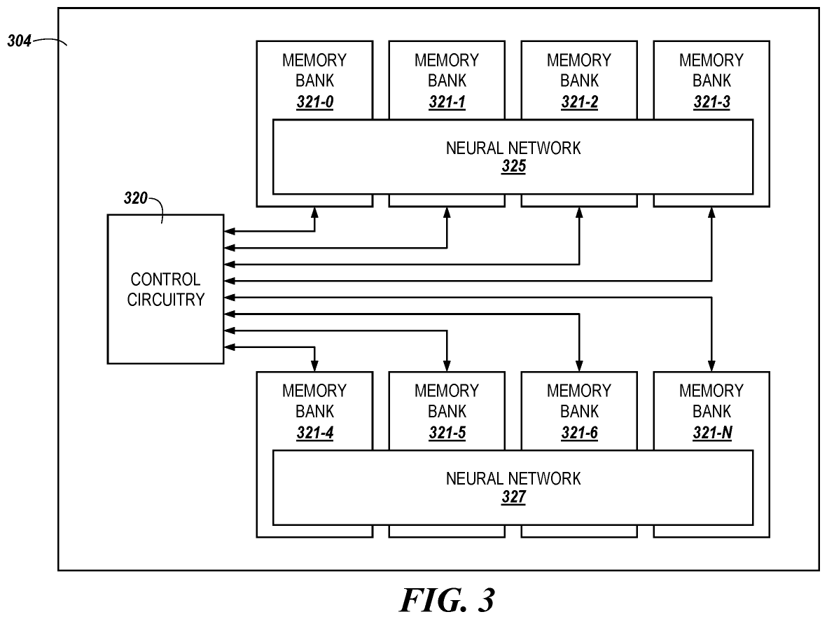

FIG. 4 is a flow diagram representing an example method 430 corresponding to a memory device to train neural networks in accordance with a number of embodiments of the present disclosure. The method 430 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At block 432, the method 430 can include writing, in a first memory bank of a memory device, data associated with an input layer or an output layer for a first neural network. The first memory bank can be analogous to one of the memory banks 221-0 to 221-N of the memory device 204 illustrated in FIGS. 2A and 2B, herein, while the first neural network can be analogous to one of the neural networks 225/227 illustrated in FIGS. 2A and 2b, herein.

At block 434, the method 430 can include writing, in a second memory bank of the memory device, data associated with an input layer or an output layer for a second neural network. The second memory bank can be analogous to one of the memory banks 221-0 to 221-N of the memory device 204 illustrated in FIGS. 2A and 2B, herein, while the second neural network can be analogous to one of the neural networks 225/227 illustrated in FIGS. 2A and 2b, herein. In some embodiments, the first neural network can be trained prior to being stored in the first memory bank, and the second neural network may not be trained prior to being stored in the second memory bank.

At block 436, the method 430 can include determining, within the memory device, one or more weights for a hidden layer of the first neural network or the second neural network, or both. For example, the method 430 can include performing a neural network training operation to train the first neural network, the second neural network by determining weights for a hidden layer of at least one of the neural networks. The method 430 can further include performing the neural network training operation to train the first neural network or the second neural network using training sets learned by the other of the first neural network or the second neural network.

As described above, in some embodiments, the method 430 can include performing the neural network training operation locally within the memory device. For example, the method 430 can include performing the neural network training operation without encumbering a host computing system (e.g., the host 102 illustrated in FIG. 1, herein) that is couplable to the memory device. In some embodiments, the method 430 can include performing the neural network training operation based, at least in part, on control signaling generated by circuitry (e.g., the control circuitry 220 illustrated in FIGS. 2A and 2B, herein) resident on the memory device.

In some embodiments, the first neural network can be a first type of neural network, and the second neural network can be a second type of neural network. For example, the first neural network can be a feed-forward neural network and the second neural network can be a back-propagation neural network, or vice versa. Embodiments are not so limited, however, and the first neural network and/or the second neural network can be perceptron neural networks, radial basis neural networks, deep feed forward neural networks, recurrent neural networks, long/short term memory neural networks, gated recurrent unit neural networks, auto encoder (AE) neural networks, variational AE neural networks, denoising AE neural networks, sparse AE neural networks, Markov chain neural networks, Hopfield neural networks, Boltzmann machine (BM) neural networks, restricted BM neural networks, deep belief neural networks, deep convolution neural networks, deconvolutional neural networks, deep convolutional inverse graphics neural networks, generative adversarial neural networks, liquid state machine neural networks, extreme learning machine neural networks, echo state neural networks, deep residual neural networks, Kohonen neural networks, support vector machine neural networks, and/or neural Turing machine neural networks, among others.

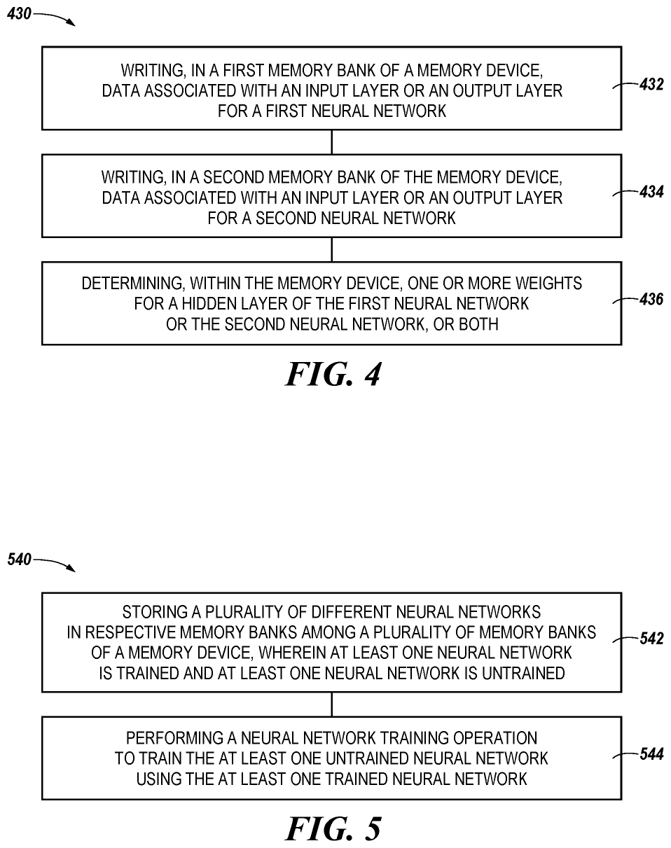

FIG. 5 is a flow diagram representing another example method 540 corresponding to a memory device to train neural networks in accordance with a number of embodiments of the present disclosure. The method 540 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At block 542, the method 540 can include storing a plurality of different neural networks in respective memory banks among a plurality of memory banks of a memory device. In some embodiments, at least one neural network can be trained and at least one neural network can be untrained. The plurality of memory banks can be analogous to the memory banks 221-0 to 221-N of the memory device 204 illustrated in FIGS. 2A and 2B, herein, while the neural networks can be analogous to the neural networks 225/227 illustrated in FIGS. 2A and 2b, herein.

At block 544, the method 540 can include performing a neural network training operation to train the at least one untrained neural network using the at least one trained neural network. As described above, in some embodiments, the method 430 can include performing the neural network training operation locally within the memory device.

In some embodiments, the memory device can include eight memory banks. For example, four trained neural networks can be stored in four respective memory banks of the memory device and four untrained neural networks can be stored in a different four respective memory banks of the memory device. In such an embodiment the method 540 can include performing the neural network training operation using respective trained neural networks to train respective untrained neural networks within the memory device. In some embodiments, the method 430 can include performing the neural network training operation to train the respective untrained neural networks substantially concurrently.

The method 540 can further include determining, by control circuitry (e.g., the control circuitry 220 illustrated in FIGS. 2A and 2B, herein) resident on the memory device, that the neural network training operation is complete and transferring, in response to signaling generated by the control circuitry, the neural network that is subject to the completed neural network training operation to circuitry external to the memory device.

In some embodiments, the method 540 can include performing, by the control circuitry, an operation to alter a precision, a dynamic range, or both, of information associated with the neural network that subject to the completed neural network training operation prior to transferring the neural network that is subject to the completed training operation to the circuitry external to the memory device.

FIG. 6 is a schematic diagram illustrating a portion of a memory array including sensing circuitry in accordance with a number of embodiments of the present disclosure. The sensing component 650 represents one of a number of sensing components that can correspond to sensing circuitry 150 shown in FIG. 1.

In the example shown in FIG. 6, the memory array 630 is a DRAM array of 1T1C (one transistor one capacitor) memory cells in which a transistor serves as the access device and a capacitor serves as the storage element; although other embodiments of configurations can be used (e.g., 2T2C with two transistors and two capacitors per memory cell). In this example, a first memory cell comprises transistor 651-1 and capacitor 652-1, and a second memory cell comprises transistor 651-2 and capacitor 652-2, etc. In a number of embodiments, the memory cells may be destructive read memory cells (e.g., reading the data stored in the cell destroys the data such that the data originally stored in the cell is refreshed after being read).

The cells of the memory array 630 can be arranged in rows coupled by access lines 662-X (Row X), 662-Y (Row Y), etc., and columns coupled by pairs of complementary sense lines (e.g., digit lines 653-1 labelled DIGIT(n) and 653-2 labelled DIGIT(n) in FIG. 6). Although only one pair of complementary digit lines are shown in FIG. 6, embodiments of the present disclosure are not so limited, and an array of memory cells can include additional columns of memory cells and digit lines (e.g., 4,096, 8,192, 16,384, etc.).

Memory cells can be coupled to different digit lines and word lines. For instance, in this example, a first source/drain region of transistor 651-1 is coupled to digit line 653-1, a second source/drain region of transistor 651-1 is coupled to capacitor 652-1, and a gate of transistor 651-1 is coupled to word line 662-Y. A first source/drain region of transistor 651-2 is coupled to digit line 653-2, a second source/drain region of transistor 651-2 is coupled to capacitor 652-2, and a gate of transistor 651-2 is coupled to word line 662-X. A cell plate, as shown in FIG. 6, can be coupled to each of capacitors 652-1 and 652-2. The cell plate can be a common node to which a reference voltage (e.g., ground) can be applied in various memory array configurations.

The digit lines 653-1 and 653-2 of memory array 630 are coupled to sensing component 650 in accordance with a number of embodiments of the present disclosure. In this example, the sensing component 650 comprises a sense amplifier 654 and a compute component 665 corresponding to a respective column of memory cells (e.g., coupled to a respective pair of complementary digit lines). The sense amplifier 654 is coupled to the pair of complementary digit lines 653-1 and 653-2. The compute component 665 is coupled to the sense amplifier 654 via pass gates 655-1 and 655-2. The gates of the pass gates 655-1 and 655-2 can be coupled to selection logic 613.

The selection logic 613 can include pass gate logic for controlling pass gates that couple the pair of complementary digit lines un-transposed between the sense amplifier 654 and the compute component 665 and swap gate logic for controlling swap gates that couple the pair of complementary digit lines transposed between the sense amplifier 654 and the compute component 665. The selection logic 613 can be coupled to the pair of complementary digit lines 653-1 and 653-2 and configured to perform logical operations on data stored in array 630. For instance, the selection logic 613 can be configured to control continuity of (e.g., turn on/turn off) pass gates 655-1 and 655-2 based on a selected logical operation that is being performed.

The sense amplifier 654 can be operated to determine a data value (e.g., logic state) stored in a selected memory cell. The sense amplifier 654 can comprise a cross coupled latch 615 (e.g., gates of a pair of transistors, such as n-channel transistors 661-1 and 661-2 are cross coupled with the gates of another pair of transistors, such as p-channel transistors 629-1 and 629-2), which can be referred to herein as a primary latch. However, embodiments are not limited to this example.

In operation, when a memory cell is being sensed (e.g., read), the voltage on one of the digit lines 653-1 or 653-2 will be slightly greater than the voltage on the other one of digit lines 653-1 or 653-2. An ACT signal and an RNL* signal can be driven low to enable (e.g., fire) the sense amplifier 654. The digit line 653-1 or 653-2 having the lower voltage will turn on one of the transistors 629-1 or 629-2 to a greater extent than the other of transistors 629-1 or 629-2, thereby driving high the digit line 654-1 or 654-2 having the higher voltage to a greater extent than the other digit line 654-1 or 654-2 is driven high.

Similarly, the digit line 654-1 or 654-2 having the higher voltage will turn on one of the transistors 661-1 or 661-2 to a greater extent than the other of the transistors 661-1 or 661-2, thereby driving low the digit line 654-1 or 654-2 having the lower voltage to a greater extent than the other digit line 654-1 or 654-2 is driven low. As a result, after a short delay, the digit line 654-1 or 654-2 having the slightly greater voltage is driven to the voltage of the supply voltage V_{CC} through a source transistor, and the other digit line 654-1 or 654-2 is driven to the voltage of the reference voltage (e.g., ground) through a sink transistor. Therefore, the cross coupled transistors 661-1 and 661-2 and transistors 629-1 and 629-2 serve as a sense amplifier pair, which amplify the differential voltage on the digit lines 654-1 and 654-2 and operate to latch a data value sensed from the selected memory cell.

Embodiments are not limited to the sensing component configuration illustrated in FIG. 6. As an example, the sense amplifier 654 can be a current-mode sense amplifier and/or a single-ended sense amplifier (e.g., sense amplifier coupled to one digit line). Also, embodiments of the present disclosure are not limited to a folded digit line architecture such as that shown in FIG. 6.

The sensing component 650 can be one of a plurality of sensing components selectively coupled to a shared I/O line. As such, the sensing component 650 can be used in association with reversing data stored in memory in accordance with a number of embodiments of the present disclosure.

In this example, the sense amplifier 654 includes equilibration circuitry 659, which can be configured to equilibrate the digit lines 654-1 and 654-2. The equilibration circuitry 659 comprises a transistor 658 coupled between digit lines 654-1 and 654-2. The equilibration circuitry 659 also comprises transistors 656-1 and 656-2 each having a first source/drain region coupled to an equilibration voltage (e.g., V_{DD}/2), where V_{DD} is a supply voltage associated with the array. A second source/drain region of transistor 656-1 is coupled to digit line 654-1, and a second source/drain region of transistor 656-2 is coupled to digit line 654-2. Gates of transistors 658, 656-1, and 656-2 can be coupled together and to an equilibration (EQ) control signal line 657. As such, activating EQ enables the transistors 658, 656-1, and 656-2, which effectively shorts digit lines 654-1 and 654-2 together and to the equilibration voltage (e.g., V_{DD}/2). Although FIG. 6 shows sense amplifier 654 comprising the equilibration circuitry 659, embodiments are not so limited, and the equilibration circuitry 659 may be implemented discretely from the sense amplifier 654, implemented in a different configuration than that shown in FIG. 6, or not implemented at all.

As shown in FIG. 6, the compute component 665 can also comprise a latch, which can be referred to herein as a secondary latch 664. The secondary latch 664 can be configured and operated in a manner similar to that described above with respect to the primary latch 663, with the exception that the pair of cross coupled p-channel transistors (e.g., PMOS transistors) included in the secondary latch can have their respective sources coupled to a supply voltage 612-2 (e.g., V_{DD}), and the pair of cross coupled n-channel transistors (e.g., NMOS transistors) of the secondary latch can have their respective sources selectively coupled to a reference voltage 612-1 (e.g., ground), such that the secondary latch is continuously enabled. The configuration of the compute component 665 is not limited to that shown in FIG. 6, and various other embodiments are feasible.

In some embodiments, the sensing circuitry 650 can be operated as described above in connection with performance of one or more operations to train neural networks (e.g., the neural networks 225 and/or 227 illustrated in FIGS. 2A and 2B, herein) stored in memory banks (e.g., the memory banks 221 illustrated in FIGS. 2A and 2B, herein), as described above. For example, data associated with the neural networks and/or training of the neural networks can be processed or operated on the sensing circuitry 650 as part of performing the training operations described above.

Although specific embodiments have been illustrated and described herein, those of ordinary skill in the art will appreciate that an arrangement calculated to achieve the same results can be substituted for the specific embodiments shown. This disclosure is intended to cover adaptations or variations of one or more embodiments of the present disclosure. It is to be understood that the above description has been made in an illustrative fashion, and not a restrictive one. Combination of the above embodiments, and other embodiments not specifically described herein will be apparent to those of skill in the art upon reviewing the above description. The scope of the one or more embodiments of the present disclosure includes other applications in which the above structures and processes are used. Therefore, the scope of one or more embodiments of the present disclosure should be determined with reference to the appended claims, along with the full range of equivalents to which such claims are entitled.

In the foregoing Detailed Description, some features are grouped together in a single embodiment for the purpose of streamlining the disclosure. This method of disclosure is not to be interpreted as reflecting an intention that the disclosed embodiments of the present disclosure have to use more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. A method, comprising:
writing, in a first memory bank of a memory device, data associated with an input layer or an output layer for a first neural network;
writing, in a second memory bank of the memory device, data associated with an input layer or an output layer for a second neural network; and
determining, within the memory device, one or more weights for a hidden layer of the first neural network or the second neural network, or both.

2. The method of claim 1, wherein the first neural network is trained prior to being stored in the first memory bank, and wherein the second neural network is not trained prior to being stored in the second memory bank.

3. The method of claim 1, wherein determining the one or more weights for the hidden layer of the first network or the second network, or both is performed as part of a neural network training operation and wherein the method further comprises performing the neural network training operation to train the first neural network or the second neural network using training sets learned by the other of the first neural network or the second neural network.

4. The method of claim 1, wherein determining the one or more weights for the hidden layer of the first network or the second network, or both is performed as part of a neural network training operation and wherein the method further comprises performing the neural network training operation locally within the memory device.

5. The method of claim 1, wherein determining the one or more weights for the hidden layer of the first network or the second network, or both is performed as part of a neural network training operation and wherein the method further comprises performing the neural network training operation without encumbering a host computing system that is couplable to the memory device.

6. The method of claim 1, wherein determining the one or more weights for the hidden layer of the first network or the second network, or both is performed as part of a neural network training operation and wherein the method further comprises performing the neural network training operation based, at least in part, on control signaling generated by circuitry resident on the memory device.

7. The method of claim 1, wherein the first neural network is a first type of neural network, and wherein the second neural network is a second type of neural network.

8. An apparatus, comprising:
a memory device comprising a plurality of banks of memory cells; and
control circuitry resident on the memory device and communicatively coupled to each bank among the plurality of memory banks, wherein the control circuitry is to:
control writing data associated with an input layer or an output layer of a first neural network in a first subset of banks of the plurality of memory banks;
control writing data associated with an input layer or an output layer of a second neural network in a second subset of banks of the plurality of memory banks; and
control performance of a neural network training operation to cause the second neural network to be trained by the first neural network by determining one or more weights for a hidden layer of the second neural network.

9. The apparatus of claim 8, wherein the first neural network is trained prior to being stored in the first subset of banks of the plurality of memory banks.

10. The apparatus of claim 8, wherein the second neural network is not trained prior to being stored in the second subset of banks of the plurality of memory banks.

11. The apparatus of claim 8, wherein the control circuitry is to control writing the data associated with the input layer or the output layer of the first neural network, writing the data associated with the input layer or the output layer of the second neural network, or performance of the neural network training operation, or any combination thereof, in the absence of signaling generated by a component external to the memory device.

12. The apparatus of claim 8, wherein the control circuitry is to:
control writing data associated with an input layer or an output layer of a third neural network in a third subset of banks of the plurality of memory banks; and
control performance of the neural network training operation to cause the third neural network to be trained by the first neural network, the second neural network, or both by determining one or more weights for a hidden layer of the third neural network.

13. The apparatus of claim 8, wherein the first subset of banks comprises half of a total quantity of memory banks associated with the memory device and the second subset of banks comprises another half of the total quantity of memory banks associated with the memory device.

14. A system, comprising:
a memory device comprising eight memory banks; and
control circuitry communicatively coupled to the eight memory banks, wherein the control circuitry is to:
control writing data associated with an input layer or an output layer of four distinct trained neural networks in four of the memory banks;
control writing data associated with an input layer or an output layer of four distinct untrained neural networks in a different four of the memory banks such that each of the eight memory banks stores a trained neural network or an untrained neural network; and
control, in the absence of signaling generated by circuitry external to the memory device, performance of a plurality of neural network training operations to cause the untrained neural networks to be trained by the trained neural networks by determining one or more weights for a hidden layer of the untrained neural networks.

15. The system of claim 14, wherein the control circuitry is to control performance of the plurality of the neural network training operations such that the plurality of neural network training operations are performed substantially concurrently.

16. The system of claim 14, wherein the control circuitry is to:
determine that at least one of the untrained neural networks has been trained; and
cause performance of an operation to alter a precision or a dynamic range, or both, of information associated with the neural network that has been trained.

17. The system of claim 14, wherein the control circuitry is to:
determine that at least one of the untrained neural networks has been trained; and
cause the neural network that has been trained to be transferred to circuitry external to the memory device.

18. The system of claim 14, wherein at least two of the trained neural networks, or at least two of the untrained neural networks, or both, are different types of neural networks.

19. The system of claim 14, wherein the control circuitry is to control performance of the plurality of neural network training operations by determining one or more weights for a hidden layer of at least one of the untrained neural networks.

20. The system of claim 14, wherein the control circuitry is resident on the memory device.
